(19) United States
(12) Patent Application Publication
(10) Pub. No.: US 2024/0344933 A1
(43) Pub. Date: Oct. 17, 2024

(54) METHOD OF IDENTIFYING ABNORMAL SOUND AND ABNORMAL SOUND IDENTIFICATION DEVICE

(71) Applicant: DENSO CORPORATION, Kariya-city (JP)

(72) Inventor: Yuji SAKAKIBARA, Kariya-city (JP)

(73) Assignee: DENSO CORPORATION, Kariya-city (JP)

(21) Appl. No.: 18/755,828

(22) Filed: Jun. 27, 2024

Related U.S. Application Data
(63) Continuation of application No. PCT/JP2022/039018, filed on Oct. 20, 2022.

(30) Foreign Application Priority Data
Dec. 27, 2021 (JP) 2021-213350

(51) Int. Cl. G01M 99/00; H04R 3/04

(52) U.S. Cl. CPC G01M 99/005; H04R 3/04

(57) ABSTRACT

A method of identifying an abnormal sound includes: a generation step of generating comparative sound data by changing a prominent one of frequency-by-frequency acoustic pressure levels based on sound data; and an identification step of identifying an abnormal sound in the sound data by outputting each of the sound data and the comparative sound data as sound and auditorily comparing outputted sounds.

### CROSS-REFERENCE TO RELATED APPLICATION

The present application is a continuation application of International Application No. PCT/JP2022/039018, filed on Oct. 20, 2022, which claims priority to Japanese Patent Application No. 2021-213350, filed on Dec. 27, 2021. The contents of these applications are incorporated herein by reference in their entirety.

### BACKGROUND

### Technical Field

The present disclosure relates to a method of identifying an abnormal sound, and an abnormal sound identification device.

### Background Art

Typically, an air conditioner, a power window device, or the like installed in a vehicle sometimes produces an abnormal sound when driven. For example, the air conditioner includes a blower motor and the blower motor itself sometimes produces an abnormal sound. The air conditioner also sometimes produces, for example, so-called wind noise which is an abnormal sound produced when air flows through a flow path. In such a case, a user may communicate the abnormal sound that he or she has noticed to, for example, an inspector or the like of a vehicle dealer and ask for repair. In such a case, the user usually uses onomatopoeia to communicate the abnormal sound that he or she has noticed to the inspector or the like. Moreover, there is a method for the inspector or the like to identify an abnormal sound, an example of which is a method in which identification of the abnormal sound is facilitated by removing, from sound data recorded at a position close to an object, sound data recorded at a distant position as a noise. The use of this method removes the sound which is audible even at the position distant from the object, which makes the abnormal sound easy for the inspector to identify.

### SUMMARY

In the present disclosure, provided is a method of identifying an abnormal sound as the following.

The method of identifying an abnormal sound includes: a generation step of generating comparative sound data by changing a prominent one of frequency-by-frequency acoustic pressure levels based on sound data; and an identification step of identifying an abnormal sound in the sound data by outputting each of the sound data and the comparative sound data as sound and auditorily comparing outputted sounds.

### BRIEF DESCRIPTION OF THE DRAWINGS

The above and other objects, features, and advantages of the present disclosure will become more apparent from the following detailed description made with reference to the accompanying drawings. The drawings are as follows.

FIG. 1 is a schematic diagram of assistance in explaining an abnormal sound identification device according to an embodiment.

FIG. 2 is a flowchart of assistance in explaining a method of identifying an abnormal sound according to an embodiment.

FIG. 3 is a diagram showing a waveform of acoustic pressure level vs. time according to an embodiment.

FIG. 4 is a diagram showing a waveform of acoustic pressure level/reference acoustic pressure level vs. frequency according to an embodiment.

FIG. 5 is a diagram showing a waveform of acoustic pressure level/reference acoustic pressure level vs. frequency according to an embodiment.

FIG. 6 is a diagram showing a waveform of acoustic pressure level/reference acoustic pressure level vs. frequency according to an embodiment.

### DETAILED DESCRIPTION OF THE PREFERRED EMBODIMENTS

[PTL 1] JP 2004-333199 A

It may be difficult for an inspector to highly accurately identify an abnormal sound that a user has noticed even by using a method of identifying an abnormal sound as described in PTL 1. That is to say, in a case where a plurality of sounds with different frequencies are produced from an object, it is difficult for an inspector to highly accurately identify which one of the sounds with the frequencies is an abnormal sound that a user has noticed.

An object of the present disclosure is to provide a method of identifying an abnormal sound and an abnormal sound identification device that enable highly accurate identification of an abnormal sound.

According to a first aspect of the present disclosure, a method of identifying an abnormal sound includes: a generation step of generating comparative sound data by changing a prominent one of frequency-by-frequency acoustic pressure levels based on sound data; and an identification step of identifying an abnormal sound in the sound data by outputting each of the sound data and the comparative sound data as sound and auditorily comparing outputted sounds.

In the above method, the comparative sound data is generated in the generation step by changing the prominent acoustic pressure level among the frequency-by-frequency acoustic pressure levels based on the sound data. Then, in the identification step, the abnormal sound in the sound data is identified by outputting the sound data and the comparative sound data as sound and auditorily comparing the outputted sounds. Consequently, for example, in communicating an abnormal sound noticed by a user to an inspector or the like, it is possible to communicate the abnormal sound with a higher accuracy as compared with by a method in which onomatopoeia is used for communication, or the like. Therefore, it is possible to highly accurately identify the abnormal sound.

According to a second aspect of the present disclosure, an abnormal sound identification device includes a generating unit configured to generate comparative sound data by calculating frequency-by-frequency acoustic pressure levels based on sound data, comparing the calculated frequency-by-frequency acoustic pressure levels with a reference acoustic pressure level set in advance, and changing a largest one of the acoustic pressure levels relative to the reference acoustic pressure level.

In the above configuration, the generating unit calculates the frequency-by-frequency acoustic pressure levels based on sound data. Then, the generating unit generates the comparative sound data by comparing the calculated frequency-by-frequency acoustic pressure levels with the reference acoustic pressure level set in advance and changing the largest acoustic pressure level relative to the reference acoustic pressure level. This makes it possible to change an acoustic pressure level at a frequency deviated from normal by using, for example, the reference acoustic pressure level corresponding to a normal sound. Consequently, for example, it is possible to change an acoustic pressure level at a frequency highly likely to correspond to an abnormal sound as compared with in a case where a change is to be made to an acoustic pressure level at a frequency that seems to be prominent when visually observing the waveform. Further, for example, it is possible to identify an abnormal sound in the sound data by outputting each of the sound data and the comparative sound data as sound and auditorily comparing the outputted sounds. Consequently, for example, in communicating an abnormal sound noticed by a user to an inspector or the like, it is possible to communicate the abnormal sound with a higher accuracy as compared with by a method in which onomatopoeia is used for communication, or the like. Therefore, it is possible to highly accurately identify the abnormal sound.

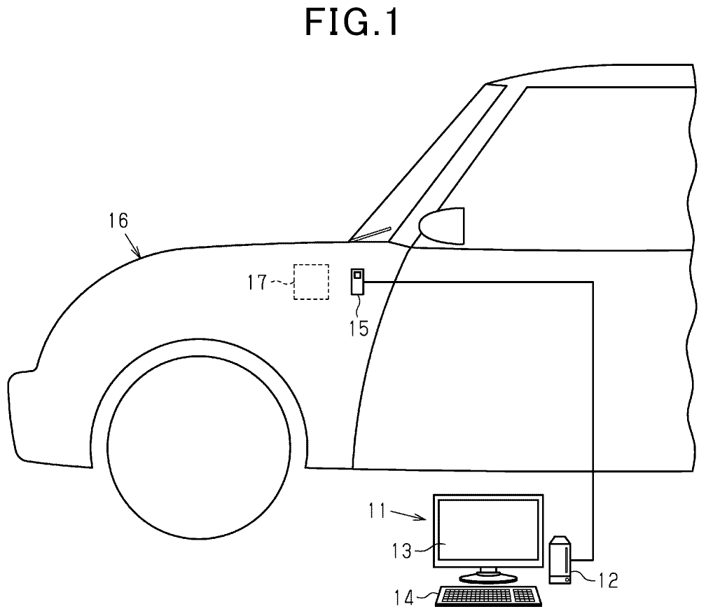

Description will be made below on an embodiment with reference to FIG. 1 to FIG. 6.

### Description of Abnormal Sound Identification Device

As illustrated in FIG. 1, an abnormal sound identification device of the present embodiment includes a PC 11 which is a personal computer. The PC 11 includes a PC body 12, a display 13 which is a display equipment, and keyboard 14 which is an input equipment for performing a variety of operations. The PC body 12 includes a CPU that is able to perform a variety of calculations, a memory that is able to store a variety of programs, data, and the like, and a speaker that is able to output an electrical signal as sound, and serves as a generator. In detail, the PC body 12 may be implemented as circuitry including 1) one or more processors that perform a variety of processes in accordance with a computer program (software), 2) one or more dedicated hardware circuits, such as application specific integrated circuits (ASICs), that perform at least a part of the variety of processes, or 3) a combination thereof. The processor includes a CPU and a memory such as RAM or ROM and the memory stores a program code or a command configured to cause the CPU to perform a process. The memory, that is, a computer-readable medium, includes any type of usable media accessible by a general-purpose or dedicated computer.

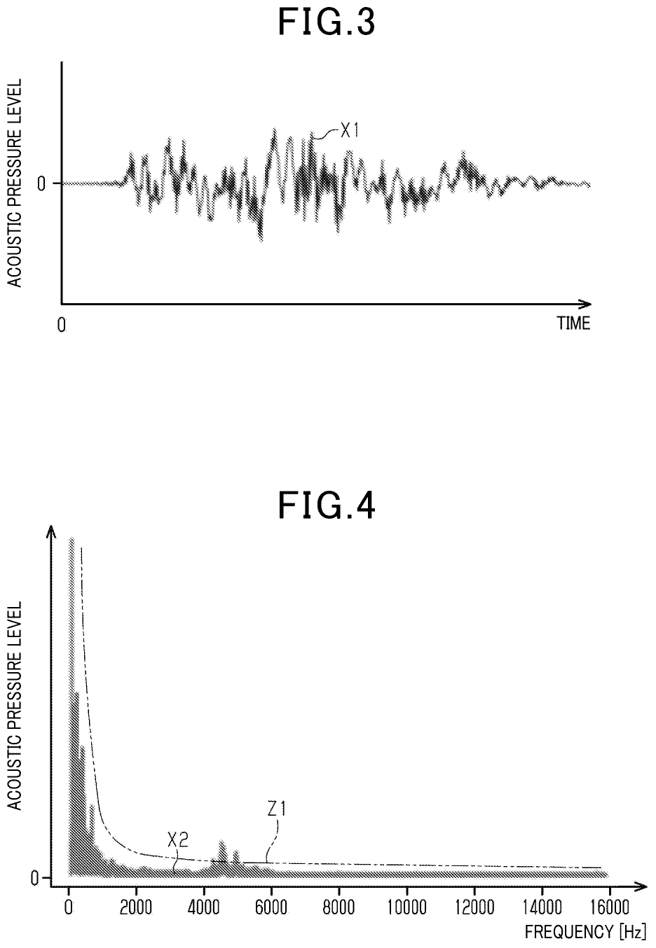

The PC body 12 performs the variety of processes in accordance with a program or the like stored in advance. The PC body 12 calculates, for example, frequency-by-frequency acoustic pressure levels (see waveform X2 in FIG. 4) based on sound data (see waveform X1 in FIG. 3) recorded by an IC recorder 15. The PC body 12 also compares the calculated frequency-by-frequency acoustic pressure levels with a reference acoustic pressure level set in advance (see waveform Z1 in FIG. 4) and generates comparative sound data by changing the largest acoustic pressure level relative to the reference acoustic pressure level. That is to say, the PC body 12 generates the comparative sound data for comparison with recorded sound data by changing the acoustic pressure level. It should be noted that the reference acoustic pressure level is data corresponding to a normal sound. For example, in a case where an air conditioner 17 equipped with a blower motor is installed in a vehicle 16 and an object is the air conditioner 17, the reference acoustic pressure level is created corresponding to a normal sound that is to be produced when the normal air conditioner 17 is driven. The reference acoustic pressure level is assumed to be data corresponding to a sound likely to be considered as being normal and acceptable. The PC body 12 also generates the comparative sound data by changing the largest acoustic pressure level relative to the reference acoustic pressure level to be relatively small. The PC body 12 of the present embodiment generates the comparative sound data by changing the largest acoustic pressure level relative to the reference acoustic pressure level to zero.

The PC body 12 is also able to output each of the sound data and the comparative sound data as sound. For example, the PC body 12 causes the speaker to alternately output the sound data and the comparative sound data as sound based on an operation with the keyboard 14.

The PC body 12 then uses the comparative sound data as the sound data and generates comparative sound data again if the abnormal sound fails to be identified. In detail, in a case where a user fails to identify an abnormal sound by, for example, auditorily comparing the sounds of the sound data and the comparative sound data, the PC body 12 generates the comparative sound data again if an operation to the effect that identification of the abnormal sound has failed is performed. The PC body 12 generates the newest comparative sound data by comparing the frequency-by-frequency acoustic pressure levels in the previous comparative sound data with the reference acoustic pressure level set in advance and changing the largest acoustic pressure level relative to the reference acoustic pressure level.

Then, for example, after generating the comparative sound data again, the PC body 12 causes the speaker to alternately output the previous comparative sound data and the newest comparative sound data as sound based on the operation of the keyboard 14.

### Description of Method of Identifying Abnormal Sound

Now, description will be given on a method of identifying an abnormal sound.

The method of identifying an abnormal sound of the present embodiment is to be performed using the above-described abnormal sound identification device.

The method of identifying an abnormal sound includes a “generation step” and an “identification step.”

In the “generation step”, comparative sound data is generated by changing a prominent acoustic pressure level among frequency-by-frequency acoustic pressure levels based on sound data. In the “generation step” of the present embodiment, the comparative sound data is generated by comparing the frequency-by-frequency acoustic pressure levels with the reference acoustic pressure level set in advance and changing, as the prominent acoustic pressure level, the largest acoustic pressure level relative to the reference acoustic pressure level. Moreover, in the “generation step”, comparative sound data is generated by changing the largest acoustic pressure level relative to the reference acoustic pressure level to be relatively small. In the “generation step” of the present embodiment, the comparative sound data is generated by changing the largest acoustic pressure level relative to the reference acoustic pressure level to zero.

In the “identification step”, an abnormal sound in the sound data is identified by outputting each of the sound data and the comparative sound data as sound and auditorily comparing the outputted sounds.

Moreover, in a case where the abnormal sound fails to be identified in the “identification step”, the comparative sound data is used as the sound data and the “generation step” and the “identification step” are again performed.

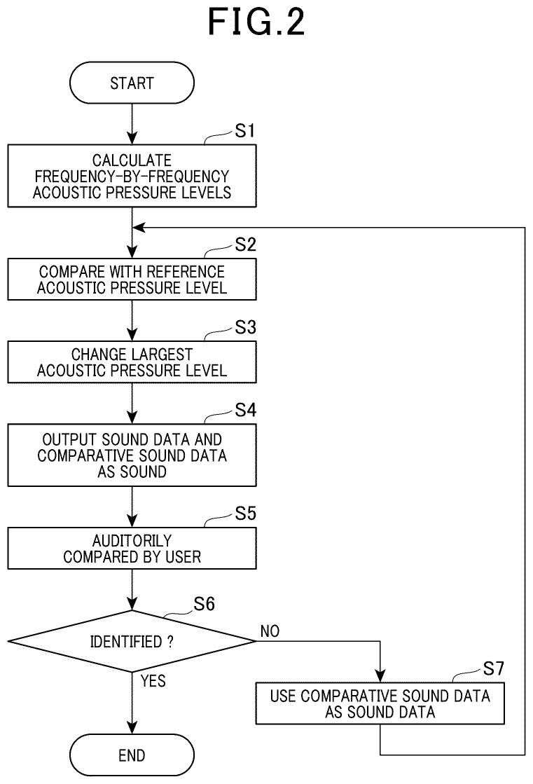

Specifically, the method of identifying an abnormal sound is to be performed in line with a flowchart illustrated in FIG. 2.

For example, in response to an inspector inputting sound data (see the waveform X1 in FIG. 3) recorded by the IC recorder 15 to the PC body 12 and subsequently performing an operation to the effect that the generation step is to be performed, the PC body 12 performs processes of Step S1 and steps subsequent thereto in the generation step. It should be noted that the sound data that is to be used by the PC body 12 at this time should be sound data at a timing when an abnormal sound is produced in the sound data recorded by the IC recorder 15.

In Step S1, the PC body 12 calculates frequency-by-frequency acoustic pressure levels (see the waveform X2 in FIG. 4) based on the sound data (see the waveform X1 in FIG. 3) and processing automatically proceeds to Step S2. It should be noted that the PC body 12 calculates the frequency-by-frequency acoustic pressure levels from the sound data by performing a fast Fourier transform at this time.

It should be noted that FIG. 3 illustrates the schematic waveform X1 of the sound data. Moreover, FIG. 4 illustrates the schematic waveform X2 of the frequency-by-frequency acoustic pressure levels.

The PC body 12 of the present embodiment causes the display 13 to display the calculated frequency-by-frequency acoustic pressure levels (see the waveform X2 in FIG. 4).

In Step S2, the PC body 12 compares the calculated frequency-by-frequency acoustic pressure levels with the reference acoustic pressure level set in advance (see the waveform Z1 in FIG. 4) and processing automatically proceeds to Step S3.

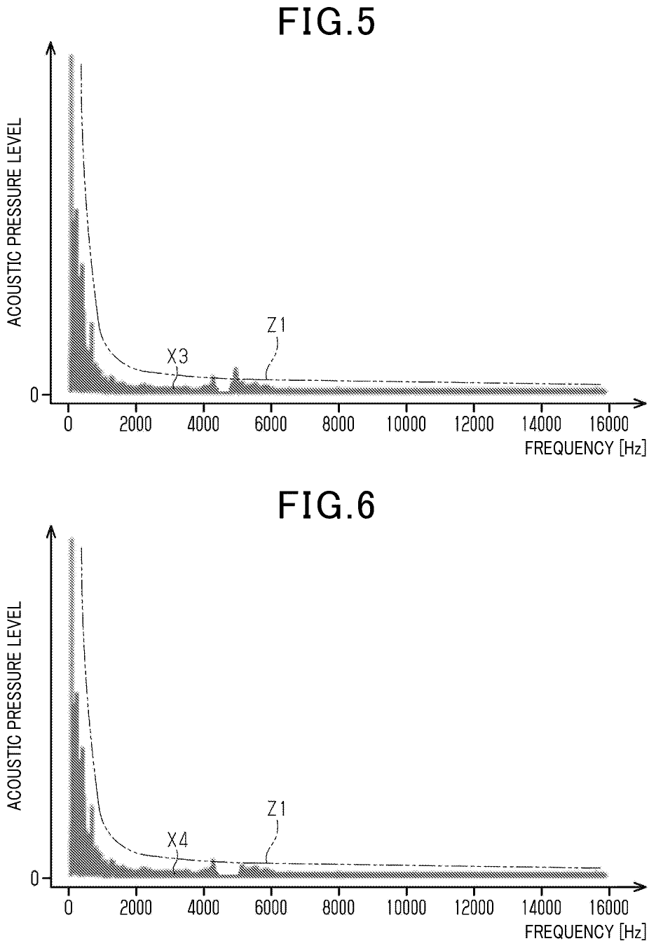

In Step S3, the PC body 12 generates comparative sound data by changing the largest acoustic pressure level relative to the reference acoustic pressure level to zero (see waveform X3 in FIG. 5). In detail, the PC body 12 changes acoustic pressure levels in a frequency band including the frequency of the largest acoustic pressure level relative to the reference acoustic pressure level to zero. The frequency band spreads in a range of several tens of Hz to several hundreds of Hz either side of the frequency of the largest acoustic pressure level. It should be noted that in generating the comparative sound data by changing the acoustic pressure levels, the PC body 12 performs an inverse fast Fourier transform to calculate the comparative sound data.

It should be noted that FIG. 5 illustrates the schematic waveform X3 in which acoustic pressure levels in a frequency band including 4500 Hz, approximately, which is the largest with respect to the reference acoustic pressure level, are changed to zero.

The PC body 12 of the present embodiment causes the display 13 to display the changed acoustic pressure levels (see the waveform X3 in FIG. 5).

Subsequently, for example, in response to the inspector performing an operation to the effect that the identification step is to be performed, the PC body 12 performs the process of Step S4 in the identification step.

In Step S4, the PC body 12 causes the speaker to alternately output the sound data and the comparative sound data as sound.

Subsequently, in Step S5, for example, a user auditorily compares the sounds outputted from the speaker.

Subsequently, in Step S6, the user determines whether an abnormal sound in the sound data is able to be identified. That is to say, the user determines whether the abnormal sound audible in the sound data has become inaudible in the comparative sound data. In response to the abnormal sound being determined to be able to be identified in Step S6, the method of identifying an abnormal sound is terminated. That is to say, in response to the abnormal sound audible in the sound data being determined to have become inaudible in the comparative sound data in Step S6, the method of identifying an abnormal sound is terminated. In contrast, in response to the abnormal sound being determined to be not able to be identified in Step S6, for example, the inspector performs an operation to the effect that the identification has failed and processing proceeds to Step S7. That is to say, in response to the abnormal sound audible in the sound data being determined to be audible also in the comparative sound data in Step S6, for example, the inspector performs the operation to the effect that the identification has failed and processing proceeds to Step S7.

In Step S7, the PC body 12 uses the comparative sound data as the sound data and processing automatically proceeds to Step S2. In detail, the PC body 12 replaces data to cause the frequency-by-frequency acoustic pressure levels (see the waveform X3 in FIG. 5) in the comparative sound data to be used as the frequency-by-frequency acoustic pressure levels calculated in Step S1 and processing proceeds to Step S2.

Thus, Step S2 to Step S6 are performed again afterward. It should be noted that in Step S3, the newest comparative sound data is generated at this time by changing, out of the frequency-by-frequency acoustic pressure levels (see the waveform X3 in FIG. 5) in the comparative sound data, the largest acoustic pressure level relative to the reference acoustic pressure level to zero (see waveform X4 in FIG. 6).

It should be noted that FIG. 6 illustrates the schematic waveform X4 in which out of the frequency-by-frequency acoustic pressure levels (see the waveform X3 in FIG. 5) in the comparative sound data, acoustic pressure levels in a frequency band including 4900 Hz, approximately, which is the largest with respect to the reference acoustic pressure level, are changed to zero.

That is to say, in a case where the abnormal sound fails to be identified in Step S6, the identification of the abnormal sound is to be repeated by repeating Step S7 and Steps S2 to Steps S6 in sequence.

Now, description will be given of the workings of the above-described embodiment.

In the generation step, the comparative sound data is generated by changing the prominent acoustic pressure level among the frequency-by-frequency acoustic pressure levels based on the sound data. Then, in the identification step, the abnormal sound in the sound data is identified by outputting the sound data and the comparative sound data as sound and auditorily comparing the outputted sounds.

Now, the effects of the above-described embodiment will be written below.

(1) For example, in communicating an abnormal sound noticed by a user to an inspector or the like, it is possible to communicate the abnormal sound with a higher accuracy as compared with by a method in which onomatopoeia is used for communication, or the like. Therefore, it is possible to highly accurately identify the abnormal sound.

(2) In the generation step by the PC body 12, the comparative sound data is generated by comparing the calculated frequency-by-frequency acoustic pressure levels with the reference acoustic pressure level set in advance and changing, as the prominent acoustic pressure level, the largest acoustic pressure level relative to the reference acoustic pressure level. This makes it possible to change an acoustic pressure level at a frequency deviated from normal by using, for example, the reference acoustic pressure level corresponding to a normal sound. Consequently, it is possible to change an acoustic pressure level at a frequency highly likely to correspond to an abnormal sound as compared with in a case where a change is to be made to an acoustic pressure level at a frequency that is supposed to be substantially prominent, for example, when the waveform is looked at, or the like. Therefore, it is possible to quickly and easily identify the abnormal sound.

(3) In a case where the abnormal sound fails to be identified in the identification step, the comparative sound data is used as the sound data and the generation step and the identification step are performed again. This makes it possible to identify an abnormal sound in the sound data by auditorily comparing sounds excluding the sound at the previously irrelevant frequency. Therefore, it is possible to highly accurately identify the abnormal sound.

(4) In the generation step by the PC body 12, the acoustic pressure level is changed to be relatively small to generate the comparative sound data. The abnormal sound thus becomes small, for example, when outputted as sound. Therefore, it is possible for a user or an inspector to highly accurately identify the abnormal sound.

The present embodiment may be altered as follows and implemented. The present embodiment and the following alteration examples may be implemented in combination with each other insofar as being technically inconsistent.
In the above-described embodiment, the comparative sound data is generated by changing, as the prominent acoustic pressure level, the largest acoustic pressure level relative to the reference acoustic pressure level in the generation step by the PC body 12, but this is not limiting. In the generation step by the PC body 12, the acoustic pressure level may be changed without using the reference acoustic pressure level.

For example, in the generation step, the comparative sound data may be generated by visually recognizing, from waveform displayed on the display 13, a prominent acoustic pressure level among the frequency-by-frequency acoustic pressure levels based on the sound data and changing the acoustic pressure level. It should be noted that in this case, the PC 11 does not need to have a special program or the like for implementing an abnormal sound identification device.
In the above-described embodiment, in a case where the abnormal sound fails to be identified in the identification step, the acoustic pressure level that is to be changed to zero is sequentially increased by using the comparative sound data as the sound data and performing the generation step and the identification step again, but this is not limiting. That is to say, in a case where the abnormal sound fails to be identified in the identification step, for example, the acoustic pressure level that is to be changed to zero may be sequentially changed instead of the acoustic pressure level that is to be changed to zero being sequentially increased.
In the above-described embodiment, in the generation step, the prominent acoustic pressure level is changed to zero, which is a relatively small value, but this is not limiting and the prominent acoustic pressure level may be changed to any other value.

For example, in the generation step, the prominent acoustic pressure level may be relatively reduced while being changed to a value larger than zero.

Moreover, for example, the prominent acoustic pressure level may be relatively increased in the generation step. Specifically, for example, the prominent acoustic pressure level may be relatively increased by reducing an acoustic pressure level different from the prominent acoustic pressure level in the generation step. This causes the abnormal sound to become large when outputted as sound, which makes it possible for a user or an inspector to highly accurately identify the abnormal sound.
In the above-described embodiment, the case where the object is the air conditioner 17 is given but the object may be changed. For example, the object may be a power window device. It should be noted that in this case, it is necessary for the reference acoustic pressure level to be created to correspond to a normal sound that is to be produced when a normal power window device is driven.
In the above-described embodiment, the abnormal sound identification device includes the PC 11 and the PC body 12 serves as the generator, but this is not limiting. For example, a mobile terminal such as a smartphone may be implemented as the abnormal sound identification device.

Although the present disclosure has been described in reference to the embodiments, it should be understood that the present disclosure is not limited to the embodiments and structures. The present disclosure also encompasses various modification examples and modifications within the equivalent range. In addition, various combinations and forms, as well as other combinations and forms including only one element, more or less, are within the scope and spirit of the present disclosure.

What is claimed is:

1. A method of identifying an abnormal sound, the method comprising:
a generation step of generating comparative sound data by changing a prominent one of frequency-by-frequency acoustic pressure levels based on sound data; and
an identification step of identifying an abnormal sound in the sound data by outputting each of the sound data and the comparative sound data as sound and auditorily comparing outputted sounds.

2. The method of identifying an abnormal sound according to claim 1, wherein
in the generation step, the comparative sound data is generated by comparing the frequency-by-frequency acoustic pressure levels with a reference acoustic pressure level set in advance and changing, as the prominent acoustic pressure level, a largest one of the frequency-by-frequency acoustic pressure levels relative to the reference acoustic pressure level.

3. The method of identifying an abnormal sound according to claim 1, wherein
in a case where the abnormal sound fails to be identified in the identification step, the comparative sound data is used as the sound data and the generation step and the identification step are performed again.

4. The method of identifying an abnormal sound according to claim 1, wherein
in the generation step, the comparative sound data is generated by reducing the acoustic pressure level.

5. The method of identifying an abnormal sound according to claim 1, wherein
in the generation step, the comparative sound data is generated by increasing the acoustic pressure level.

6. An abnormal sound identification device comprising:
a generating unit configured to generate comparative sound data by calculating frequency-by-frequency acoustic pressure levels based on sound data, comparing the calculated frequency-by-frequency acoustic pressure levels with a reference acoustic pressure level set in advance, and changing a largest one of the acoustic pressure levels relative to the reference acoustic pressure level.

7. The abnormal sound identification device according to claim 6, wherein
the generating unit is configured to, in response to an abnormal sound failing to be identified, use the comparative sound data as the sound data and generate the comparative sound data again.

8. The abnormal sound identification device according to claim 6, wherein
the generating unit is configured to generate the comparative sound data by reducing the acoustic pressure level.

9. The abnormal sound identification device according to claim 6, wherein
the generating unit is configured to generate the comparative sound data by increasing the acoustic pressure level.
